(19) United States
(12) Patent Application Publication
(10) Pub. No.: US 2009/0326690 A1
(43) Pub. Date: Dec. 31, 2009

(54) AUDIO WATERMARKING TECHNIQUE FOR MOTION PICTURE PRESENTATIONS

(76) Inventors: Daniele Turchetta, Rome (IT); Giuseppe Piccardi, Rome (IT); Massimo Masini, Los Angeles, CA (US)

Correspondence Address: Robert D. Shedd, Patent Operations;THOMSON Licensing LLC, P.O. Box 5312, Princeton, NJ, 08543-5312, US

(21) Appl. No.: 12/309,447

(22) PCT Filed: Jul. 17, 2007
(86) PCT No.: PCT/IB2007/002008

§ 371 Date: Jan. 16, 2009

(30) Foreign Application Priority Data
Jul. 19, 2006 (IT) MI2006A001405

(51) Int. Cl. G06F 17/00

(52) U.S. Cl. 700/94; 704/E19.009

(57) ABSTRACT

Audio watermarking of a motion picture film containing a DTS® sound track occurs by selectively deleting one or more identifiers that appear within the synchronizing codes in the sound track. Upon screening of the film by a projector a DTS® reader will send information to a DTS® CD player which can detect the absence of the identifier and generate the audio watermark accordingly.

### TECHNICAL FIELD

This invention relates to watermarking on a motion picture presentation for the purpose of tracing the source of the presentation.

### BACKGROUND ART

The widespread distribution of illegally made copies of motion picture film continues to plague the movie industry. Those who make illegal copies, often referred to as “media pirates, do so in a variety of ways. Unsophisticated media pirates often make use of a camcorder or similar type of recording device smuggled into a movie theater to illegally record a copy of a feature presentation. More sophisticated media pirates collude with theater personnel, for example the theater owner or theater projectionist, to allow the pirates to make a copy of the motion picture release print through optical or electronic means, affording a much higher quality copy.

In a effort to reduce the incidence of piracy, many movie studios now require that each release print distributed to a movie theater contain a unique watermark, to enable tracing the release print to the particular destination that received it. Thus, the release print shipped to a given location; say Rome, Italy, will have a different watermark than the release print of the same movie shipped to New York City in the United States. The nature of the watermark, and the process by which it is embedded on the release print, assures that in most instances, the watermark will appear in any illegally made copy. Thus, by forensically analyzing the watermark in the illegally made copy, a movie studio, or its designated agent can identify the particular release print that served as the master for that illegally made copy. Knowing the identify of the release print that served as the master for the illegally made copy allows the movie studio to identify the movie theater than received the identified release print and take appropriate action, particularly if personnel at that theater collaborated in the copying.

Presently there exist both optical watermarks and audio watermarks for uniquely identifying motion picture film. Optical watermarks generally have a greater impact on the movie viewer and are more likely to be uncovered by sophisticated pirates. Audio watermarks generally do not suffer from this disadvantage. However, audio watermark suffer from other disadvantages. Pirated movie copies, whether made on a DVD or videotape generally carry audio information derived from a different source than the film itself. For example, a typical movie print film distributed within the United States will have video information obtained from a US version film print and audio from an English language dubbing version.

Thus, a need exists for an audio watermarking technique which overcomes the aforementioned disadvantage.

### BRIEF SUMMARY OF THE INVENTION

Briefly, in accordance with a first aspect of the present principles, there is provided a method for watermarking a motion picture presentation, such as a film, having sound reproducing information, such as a sound track, having one or more identifiers in the sound track. The method comprises the step of selecting at least one identifier for deletion. The selectively deleted identifiers enable generation of a unique watermarking during screening of the presentation.

In accordance with another aspect of the present principles, there is provided a method for generating a watermark during screening of a motion picture presentation having sound reproducing information, including identifiers which are selectively deleted. The method commences by detecting which identifiers have been deleted. Thereafter, an audio watermark is generated unique to the selectively deleted identifiers.

In accordance with yet another aspect of the present principles, there is provided a method for recording a motion picture presentation having sound reproducing information including identifiers that are selectively deleted. The method comprises the step of recording an audio watermark generated in accordance with the selectively deleted identifiers during screening of the motion picture presentation.

### BRIEF DESCRIPTION OF THE DRAWINGS

FIG. 1 depicts a portion of a prior art motion picture film showing the location of various sound tracks in the film;

FIG. 2 depicts a block diagram of a motion picture sound system for reproducing digital sound and for generating an audio watermark in accordance with the present principles;

FIG. 3 depicts a flow chart depicting the steps of a method in accordance with the present principles for selecting one or portions of a motion film in which one or more audio watermarks will appear during screening of that presentation;

FIG. 4 depicts a block schematic diagram of a system, in accordance with the present principles for controlling the printing of a motion picture film to cause the generation of one or more an audio watermarks in the film during screening;

FIG. 5 depicts an electrical schematic of a control circuit for controlling one or more lasers within the printing apparatus of FIG. 4; and

FIG. 6 depicts an apparatus, in accordance with the present principles for screening a pirated movie presentation copy to identify one or more audio watermarks within that copy.

### DETAILED DESCRIPTION

The present invention provides a technique for watermarking a motion picture presentation, and more particularly, a motion picture film. To appreciate the watermarking technique of the present principles, a brief description of various sound information carried by a motion picture film, as well as a brief description of the technique for reproducing such sound information will prove useful.

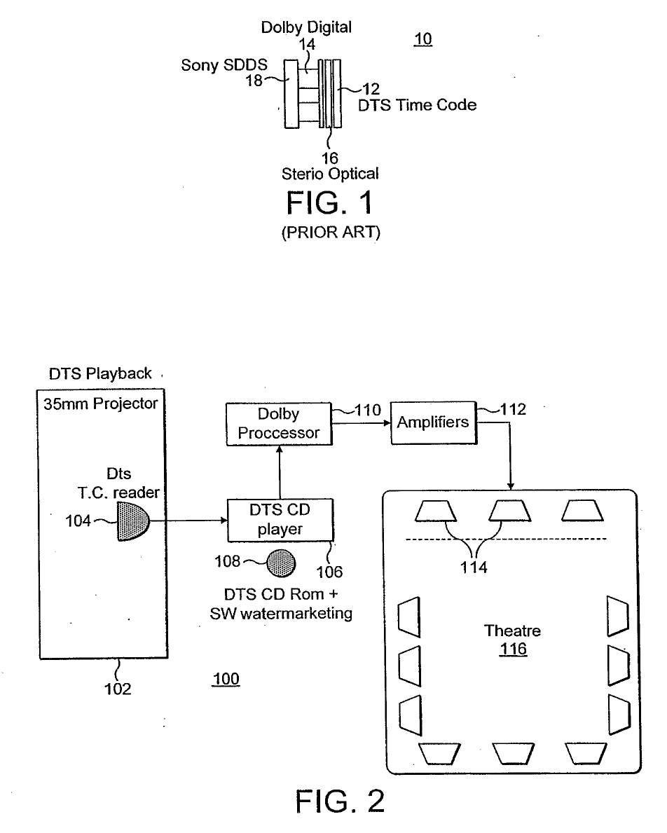

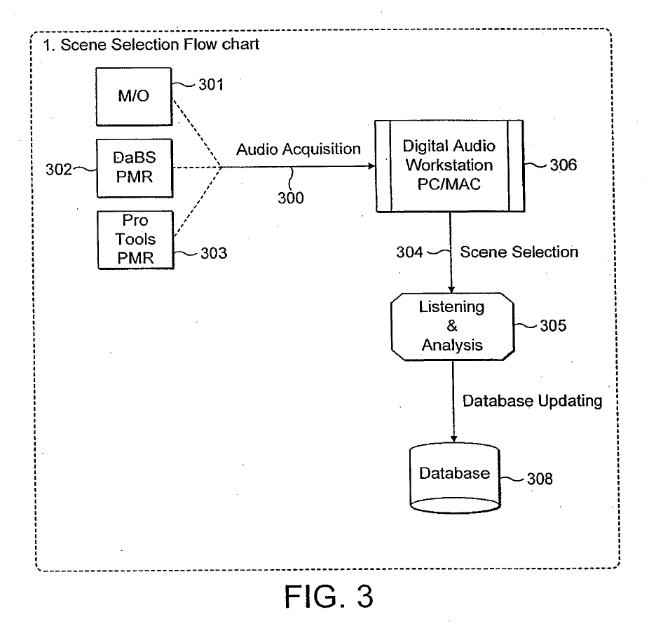

FIG. 1 depicts a piece of motion picture film 10 in accordance with the prior art. Present day motion picture film, such as the film 10 typically carries four different types of sound reproducing information. In practice, each type of sound reproducing information bears the designation “sound track” since such information appears in a linear manner along the film outside the picture area (not shown). The four sound tracks typically comprise a Digital Theater Sound® (DTS) track 12, a Dolby® digital sound track 14, a stereo optical sound track 16 and a SONY® SDDS sound track 18. The sound reproducing information carried by the DTS sound track 12 differs from that carried by the other tracks 14, 16 and 18. As described in greater detail with respect to FIG. 2, the DTS® sound track 12 comprises time code information for synchronizing the visual information in the film 10 of FIG. 1 to audio data recorded on a CD ROM.

FIG. 2 depicts a block diagram of a motion picture sound system 100 in accordance with the present principles for reproducing DTS audio in accordance with the DTS sound track 12 on the motion picture film 10 of FIG. 1. The sound system 100 of FIG. 2 comprises a projector 102, typically a 35 mm projector, although in some instances, the projector could comprise 70 mm or such other size as is used to screen the motion picture film 10 of FIG. 1. The projector 102 includes a reader 104 for reading the DTS time code within the DTS® sound track 12 of FIG. 1. While not shown, the projector 102 typically will include other readers in addition to reader 104, for reading the sound tracks 14, 16 and 18 all of FIG. 1.

The DTS® time code read by the reader 104 of FIG. 2 passes to a DTS® CD player 106 that plays at least one CD-ROM 108 containing audio data for reproduction in connection with screening the visual information carried by the film 10 of FIG. 1. In other words, the DTS® CD player 106 plays the CD-ROM 108 as the projector 102 projects the film 10. The DTS CD player 106 makes use of the time codes on the DTS sound track 12 of FIG. 1 read by the reader 104 to synchronize the audio data on the CD ROM 108 with the visual information on the film 10. To that end, the CD-ROM 108 typically contains software read by the DTS® CD player 106 to facilitate synchronization of the audio data. The software could reside elsewhere besides being on the CD-ROM 108. The audio data reproduced by the DTS® CD player 106 typically undergoes processing by an audio processor 110, usually a DOLBY® processor, prior to receipt at one or more amplifiers 112 which drive a set of speakers 114 within a theater 116.

In addition to enabling the DTS® CD player 106 to playback audio data, the software enables the CD player to generate a watermark (e.g., an audio tone or predetermined combination of tones) upon detecting the absence of one or more identifiers selectively deleted from the film 10 in accordance with the present principles. This is best understood as follows. The DTS® sound track 12 of FIG. 1 contains a set of time codes that enable the DTS® CD player 106 to synchronize the audio data during playback as discussed above. The set of time codes includes a serial number that repeats at spaced intervals along the film. In an illustrative embodiment, the time code is recorded on the film 10 of FIG. 1 at a rate of 30 feet per second (fps) with the serial number appearing every 12.8 film frames when the film is projected @24 fps. Thus, the serial numbers appear at spaced apart locations on every DTS feature reel with recorded DTS time codes.

As discussed hereinafter, one or more of the serial numbers can be selectively deleted during printing (i.e., manufacture) of each individual film. The deleted serial numbers yield a pattern unique to the film. For example, a given reel of a film could have a single serial number deleted at a known location on the film, while another reel of a different film could have a pair of consecutively deleted serial numbers. The absence a serial number causes the software within the DTS® CD player 106 to produce a specific audio watermark, for example, an audio tone or combination of tones. For example, the audio watermark could comprise a 192 Hz. or 210 Hz or 240 Hz. square wave that lasts for 2 frames when the film 10 undergoes projection at 24 fps. Typically, the audio watermark appears from the center channel although the audio watermark could appear from the right or left channels just as easily. The audio watermark has a variable level selected in accordance with the average level of the audio associated with the scene in which the audio watermark is heard. In this way, the audio associated within the scene can serve to at least partially mask the audio watermark. Another option includes modifying the digital-to-analog conversion that occurs in connection with the audio reproduction in real time to accomplish low band masking.

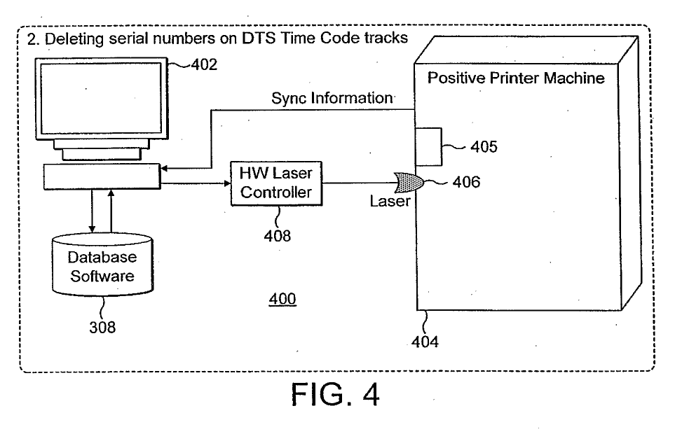

FIG. 3 depicts a flow chart that depicts the steps of a process in accordance with the present principles for establishing desirable locations within the film 10 for placing the audio watermark by deleting one or more serial numbers within the DTS® time code corresponding to such a scene. The process commences at step 300 during which acquisition of audio information associated with the film occurs. The audio acquired during step 300 can exist at a variety of sources. For example, the audio could exist on a monaural optical (mono-optical) DTS sound track 301. Alternatively, the audio can exist as a digital file that resides at a digital source, such as a digital audio recorder 302, or disc drive 303.

Following audio acquisition, scene selection occurs during step 304. The process of selecting a scene during step 304 typically entails listening to the audio of the various scenes in the film 10 of FIG. 1 and making an analysis to determine the suitability of placing the watermark in a given scene during step 305. For example, a scene within the movie having very little if any dialogue and little if any background noise would likely constitute a poor choice for an audio watermark because the prominence the mark would have. On the other hand, a scene with a large amount of ambient noise would likely prove a much better choice because the ambient noise would mask the audio watermark.

To carry out the steps of audio acquisition (step 300) and scene selection (step 304), an operator will typically make use of a digital audio work station 306, usually taking the form of a personal computer that makes use of either the PC or Apple Macintosh® computer operating system. The results of the scene selection undergo storage in a database 306 for later use in printing the film as discussed hereinafter.

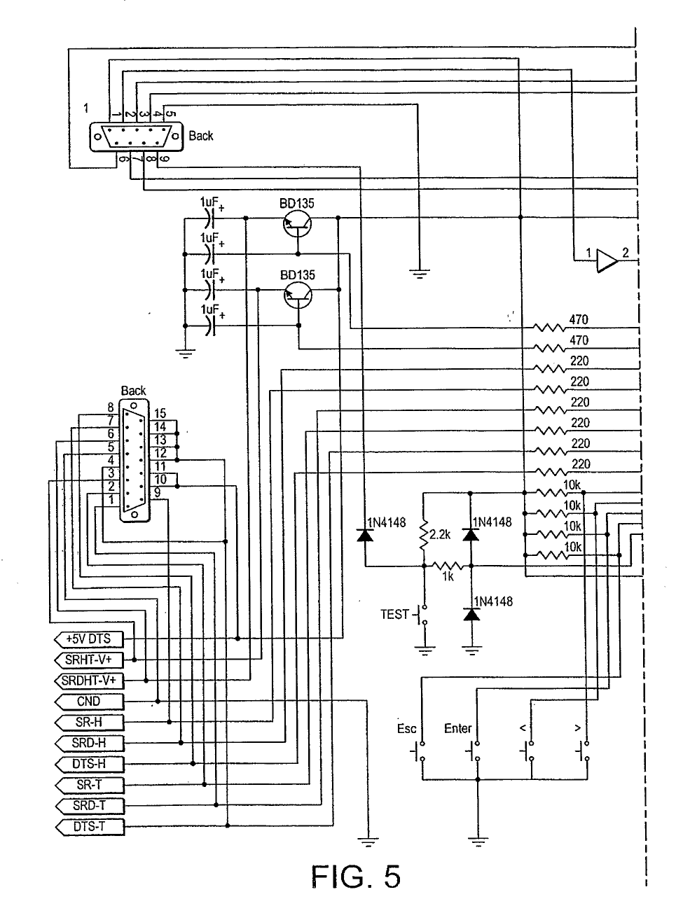

FIG. 4 illustrates a block schematic diagram of a system 400 in accordance with the present principles for selectively deleting one or more serial numbers within the DTS® sound track 12 of FIG. 1 during printing, that is, during manufacturing of the film 10 of FIG. 1 to create to one or more audio watermarks that serve to uniquely identify the film. The system includes a computer 402, such as a personal computer or the like having a connection to the database 306 to obtain information regarding the selected scene(s) where an audio watermark should appear. The computer 402 also has a connection to a print machine 404, as are well known in the art, for printing motion picture film, such as film 10 of FIG. 1. Such machines typically include a set of lights for exposing a length of positive print film using an exposed negative print for this purpose. The computer 402 receives synchronizing information from the print machine 404 indicative of which frame of the print lies in the path of a laser source 406 on the machine.

As discussed previously relative to FIG. 3, the database 306 contains information of the scenes within the film which will have their DTS® time code serial numbers selectively deleted to produce the desired audio watermark(s). The computer 402 makes use of that information in the database 306, together with the synchronizing information from the print machine 404, to determine which locations along the film printed by the machine 404 to activate the laser source 406 through a laser controller 408. Stated another way, when the computer 402 determines that the laser 406 now aligns with a frame containing a scene that should contain an audio watermark, the computer causes the controller 408 to trigger the laser 406 to obliterate the serial number on the DTS® sound track associated with that frame.

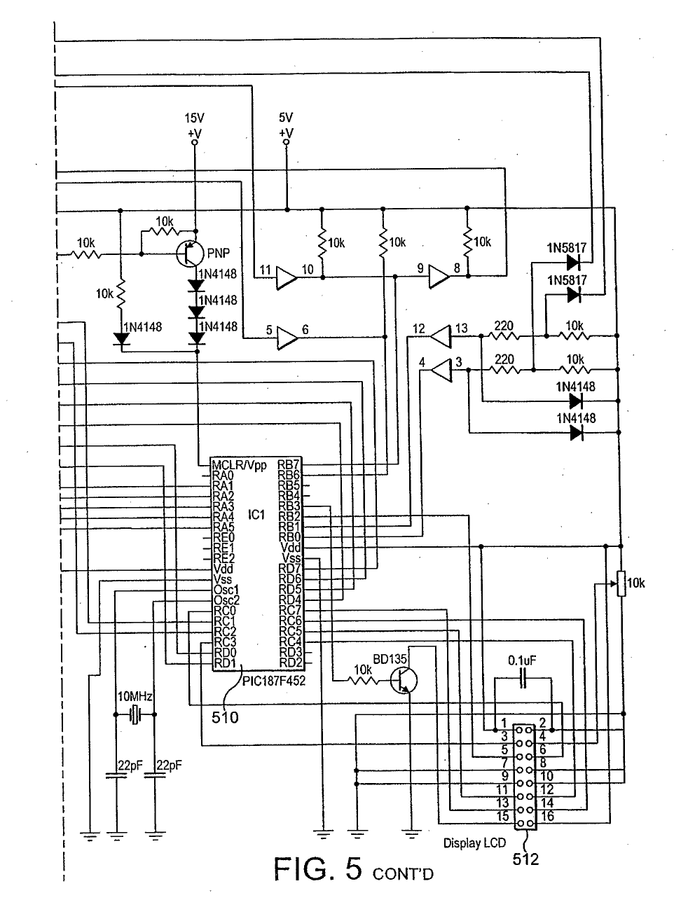

FIG. 5 depicts a block schematic of the laser controller 408 for controlling the laser source 406 on the print machine 404 of FIG. 4. At the heart of the laser controller 408 of FIG. 5 is a microprocessor 510 which serves to control the laser source 406 of FIG. 4. In practice the laser source 406 of FIG. 4 has an optical wavelength a 650 nm, a power level of 20 nW and a modulation frequency as high as 155 MHz. The microprocessor 510 of FIG. 5 has a connection to an external 1024 line encoder (not shown) that provides a synchronization reference to enable the microprocessor to perform the calculations, in terms of the perforations on the film as to where the laser will expose the film. The microprocessor 510 has software that allows the microprocessor to:
Select the type of the encoder providing the synchronization reference;
Select the type of sprocket on the film;
Adjust the power of the laser source;
Adjust delay lines (not shown);
Select a laser source test function;
Select the count unit of the encoder and
Save parameters associated microprocessor control of the laser source.
   In addition to the microprocessor 510, the laser controller 408 also includes a display device 512, typically a liquid crystal display, for providing information indicative of various aspects of the controller operation.

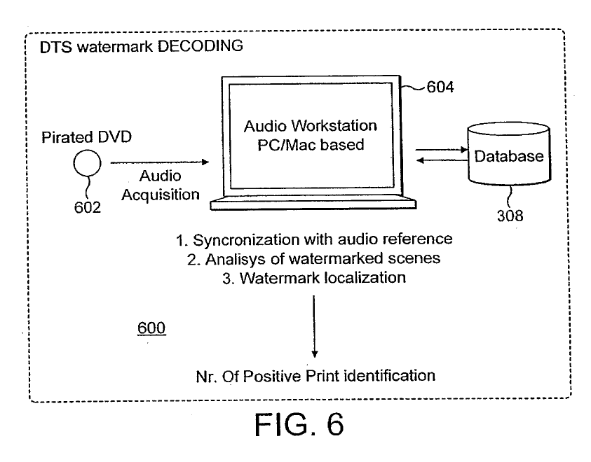

FIG. 6 depicts a block schematic diagram of a system 600, in accordance with an aspect of the present principles for conducting forensic analysis of a pirated copy 602 of a motion picture film containing one or more audio watermarks provided in the manner discussed previously. The pirated copy 602 can take various forms, such as a DVD, a video tape, or motion picture film for example. Regardless of its form, the pirated copy 602, when recorded from a film having the audio watermark in accordance with the present principles, will itself contain the watermark.

To examine the pirated copy 602, an operator will make use of an audio work station 604 connected to the database 306 which as discussed contains information as to the nature and location(s) of the audio watermark(s) in the film, as well as the identity of the film, as assigned during printing. The audio work station typically takes the form of a personal computer having either a PC or Apple Macintosh® operating system. With the aid of the audio work station 604, the operator will first acquire the audio from the pirated copy 602 and thereafter undertake synchronization with an audio reference file which contains the audio watermarks created in the manner described previously. Using the work station 604, the operator will undertake an analysis of the watermarked scenes, as determined from the data from the database 306 for the purpose of localizing the audio watermarks. The process of localizing the watermarks entails determining the location(s) of the audio watermarks in the pirated copy 602. From a knowledge of the location(s) in the pirated copy 602 where the audio watermarks occur, the operator can identify the particular release print from which served as the master for the pirated copy.

The foregoing describes a technique for providing one or more audio watermarks in a motion picture presentation for uniquely identifying that presentation to provide a mechanism for tracking the source of illegally made copies.

What is claimed is:

1. A method for watermarking a motion picture presentation having sound reproducing information thereon, including identifiers, comprising the step of:
selecting at least one identifier within the sound reproducing information for deletion such that screening of the presentation will yield an audio watermark unique to the at least one identifier selected for deletion.

2. The method according to claim 1 wherein
the motion picture presentation comprises a film whose sound reproducing information comprises synchronizing codes in a sound track along the length of the film;
the identifiers comprise serial numbers that appear with the synchronizing codes at spaced locations along the sound track, and
the selecting step further comprises the step of selecting at least one serial number for deletion.

3. The method according to claim 1 wherein the selecting step further comprises the steps of:
acquiring audio associated with at least one scene in the motion picture presentation having an identified associated with the at least one scene;
analyzing audio associated with the at least one scene; and
selecting the identifier associated with the at least one scene for deletion if the audio within the at least one scene will at least partially mask a watermark generated in accordance with the identifier selected for deletion.

4. The method according to claim 1 further comprising the step of updating a database with information indicative of the selected identifier.

5. The method according to claim 3 further comprising the step of selecting the identifier associated with each of at least three scenes for deletion.

6. A method of generating an audio watermark during screening of a motion picture film presentation having sound reproducing information thereon, including at least one identifier that has been selectively deleted, comprising the steps of:
detecting which identifiers within the presentation have been deleted; and
generating a unique audio watermark in accordance with the deleted identifiers detected.

7. The method according to claim 6 wherein the step of generating a unique audio watermark includes the step of generating a square wave signal of a frequency between 192 to 210 Hz.

8. The method according to claim 6 wherein the motion picture presentation comprises a motion picture film and wherein the step of generating the audio watermark comprises the step of generating the audio watermark for a duration of at least 2 frames within the film.

9. The method according to claim 6 wherein the step of generating the audio watermark comprises the step of masking the audio watermark by varying its level.

10. A method of recording a motion picture film having sound reproducing information thereon, including identifiers at least one of which is selectively deleted, comprising the step of:
recording an audio watermark generated during screening of the film in accordance with the at least one selectively deleted identifier.

11. The method according to claim 10 wherein the audio watermark comprises a square wave signal of a frequency between 192 to 210 Hz.

12. The method according to claim 11 wherein the recording step comprises the step of recording the audio watermark for a duration of at least 2 frames within the film.

13. Apparatus for identifying locations for audio watermarks in a motion picture presentation having sound reproducing information thereon, comprising
means for acquiring audio data associated with the sound reproducing information in the motion picture presentation;
means for analyzing the acquired audio to select at least one scene in the motion picture scene to include an audio watermark to uniquely identify the motion picture presentation; and
means for storing information identifying the at least one selected scene to contain the audio watermark.

14. A system for placing at least one audio watermark in a motion picture film having sound reproducing information thereon, including identifiers, comprising:
a motion picture film printer for printing a motion picture film to create the sound reproducing information and the identifiers;
a laser carried by the printing machine for deleting identifiers within the sound reproducing information;
a database storing information indicative of at least one identifier within the sound reproducing information for deletion; and
means responsive to (a) synchronizing information generated motion picture film printer indicative film position relative to the laser and (b) information in the database for indicative of the identifier for deletion controlling the laser to delete the identifier so that upon screening of the film, the deleted identifier will trigger the generation of an audio watermark.

15. A system for analyzing a pirated copy of a motion picture presentation, comprising:
a database containing reference audio associated with the motion picture presentation, the reference audio containing at least one audio watermark which uniquely identifies a particular valid copy of the motion picture presentation;
means for acquiring audio from the pirated copy;
means for synchronizing the acquired audio with the reference audio associated with the motion picture presentation; and
means for detecting a watermarking in the pirated copy for comparison to the at least one watermark in the reference audio determine the identity of the valid copy from which the pirated copy was recorded.
